(19) United States
(12) Patent Application Publication
(10) Pub. No.: US 2019/0138988 A1
(43) Pub. Date: May 9, 2019

(54) APPARATUS AND METHOD FOR DISPLAYING CONTENT WITH DELIVERY VEHICLE

(71) Applicant: Walmart Apollo, LLC, Bentonville, AR (US)

(72) Inventors: Donald R. High, Noel, MO (US); David C. Winkle, Bella Vista, AR (US)

(21) Appl. No.: 16/302,075

(22) PCT Filed: May 18, 2017
(86) PCT No.: PCT/US2017/033249

§ 371 Date: Nov. 15, 2018

Related U.S. Application Data
(60) Provisional application No. 62/338,326, filed on May 18, 2016.

(51) Int. Cl. G06Q 10/08; G05D 1/02; G05D 1/10; G08G 5/00

(52) U.S. Cl. CPC G06Q 10/08355; G05D 1/0212; G05D 2201/0213; G05D 1/0278; G08G 5/0069; G05D 1/101

(57) ABSTRACT

Systems, apparatuses, and methods are provided herein for providing delivery vehicle content display. A system for delivery vehicle content display comprises an unmanned delivery vehicle, a display device on an exterior of the unmanned delivery vehicle, a sensor configured to collect data for determining context information associated with the unmanned delivery vehicle during a delivery trip, and a control circuit coupled to the display device and the sensor. The control circuit being configured to cause the display device to display content comprising a content item selected from a plurality of content items based on the context information during the delivery trip and update the content displayed on the display device based on a change in the context information associated with the unmanned delivery vehicle during the delivery trip.

### CROSS-REFERENCE TO RELATED APPLICATION

This application claims the benefit of the following U.S. Provisional Application No. 62/338,326 filed May 18, 2016, which is incorporated herein by reference in its entirety.

### TECHNICAL FIELD

This invention relates generally to unmanned vehicles.

### BACKGROUND

An unmanned vehicle or uncrewed vehicle generally refers to a vehicle configured to travel without a person on board. Unmanned vehicles may be remote controlled or remote guided vehicles and/or may be autonomous vehicles capable of navigating by sensing their environment.

### BRIEF DESCRIPTION OF THE DRAWINGS

Disclosed herein are embodiments of apparatuses and methods for providing delivery vehicle content display. This description includes drawings, wherein:

FIG. 1 is a block diagram of a system in accordance with several embodiments.

FIG. 2 is a flow diagram of a method in accordance with several embodiments.

FIG. 3 is a flow diagram of another method in accordance with several embodiments.

FIG. 4 is an illustration of an unmanned aerial delivery vehicle in accordance with several embodiments.

FIG. 5 is an illustration of an unmanned ground delivery vehicle in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for providing delivery vehicle content display. A system for delivery vehicle content display comprises an unmanned delivery vehicle, a display device on an exterior of the unmanned delivery vehicle, a sensor configured to collect data for determining context information associated with the unmanned delivery vehicle during a delivery trip, and a control circuit coupled to the display device and the sensor. The control circuit being configured to cause the display device to display content comprising a content item selected from a plurality of content items based on the context information during the delivery trip and update the content displayed on the display device based on a change in the context information associated with the unmanned delivery vehicle during the delivery trip.

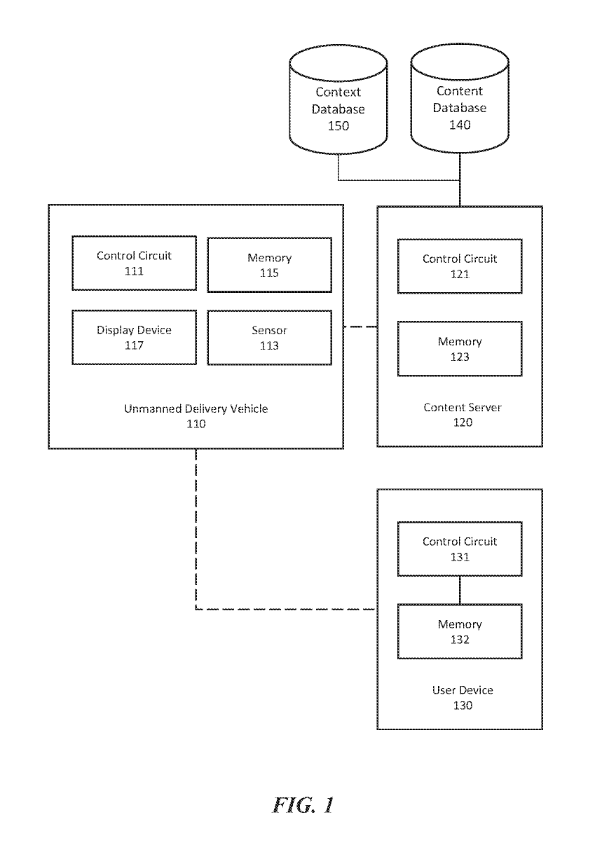

Referring now to FIG. 1, a system for providing delivery vehicle content display is shown. The system comprises an unmanned delivery vehicle 110, a content server 120, and a user device 130.

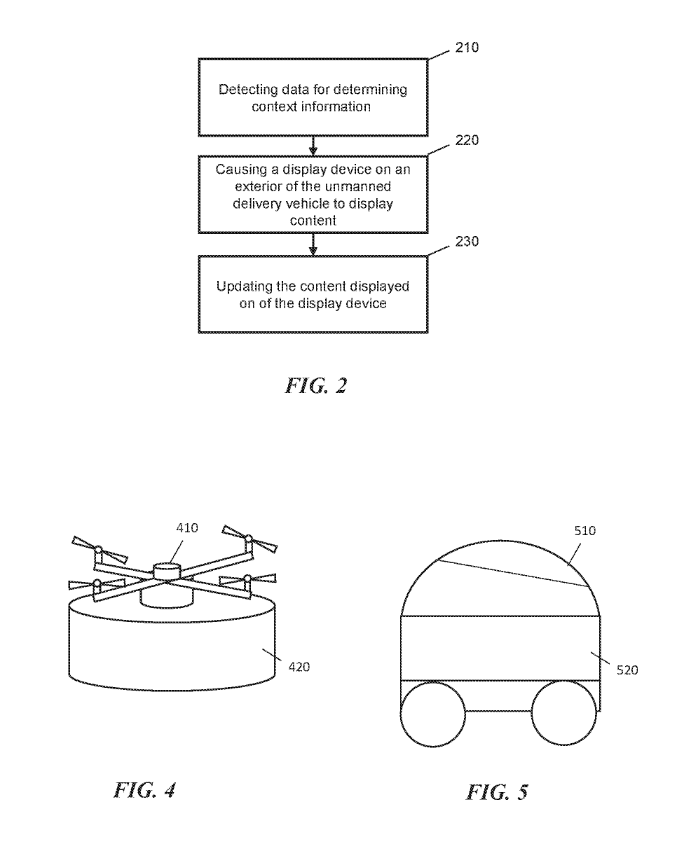

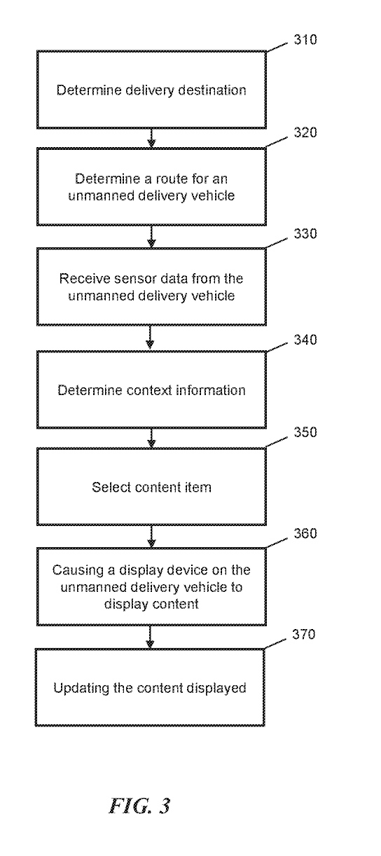

The unmanned delivery vehicle 110 includes a control circuit 111, a memory 115, a sensor 113, and a display device 117. The control circuit 111 may comprise a central processing unit, a processor, a microprocessor, and the like. The control circuit 111 may be configured to execute computer readable instructions stored on the computer readable storage memory 115. The computer readable storage memory 115 may comprise volatile and/or non-volatile memory and have stored upon it a set of computer readable instructions which, when executed by the control circuit 111, causes the control circuit 111 to alter the content displayed on the display device 117 based at least on the data collected by the sensor 113 and/or instructions received from the content server 120. In some embodiments, the control circuit 111 may comprise the navigation controller of the unmanned delivery vehicle 110 configured to drive and steer the unmanned delivery vehicle 110 based on instructions received from the content server 120. In some embodiments, the computer executable instructions may cause the control circuit 111 of the unmanned delivery vehicle 110 to perform one or more steps in the methods and processes described with reference to FIGS. 2-3 herein. In some embodiments, the memory 115 may further store content items such as advertisements, videos, graphics, text, audio, etc. configured to be displayed on the display device 117. In some embodiments, at least some content items may be preloaded onto the memory 115 prior to a delivery trip. In some embodiments, content items may be streamed and/or downloaded from the content server 120 to the unmanned delivery vehicle 110 during a delivery trip.

The sensor 113 may comprise a device for gathering data to determine context information of the unmanned delivery vehicle 110. In some embodiments, the sensor 113 may comprise one or more of a global positioning system (GPS) sensor, a mobile data transceiver, and a Wi-Fi transceiver. In some embodiments, the sensor 113 may provide data for determining the location of the unmanned delivery vehicle 110 and the location information may be used to retrieve one or more of an area demographic information, an area environmental condition, an area building information, area traffic volume, and an area customer purchase history to use as context information. In some embodiments, the sensor 113 may communicate with one or more of a user device 130, a wireless router, and a mobile data tower to collect context information. For example, the user device 130 may include a mobile application for communicating with the unmanned delivery vehicle 110 and/or the content server 120 and providing the user's information. The provided user information may comprise one or more of user location, user preference, user demographic, user purchase history, etc. In some embodiments, information related to one or more users associated with user devices 130 within the range of the sensor 113 of the unmanned delivery vehicle 110 may be used as context information in selecting content to display on the display device 117. In some embodiments, the sensor 113 may comprise an environmental sensor such as a temperature sensor, a humidity sensor, a light sensor, a noise level sensor, a wind sensor, an air quality sensor, and the like and the measured environmental conditions may comprise context information in selecting content to display.

The display device 117 may comprise any display device configured to be viewed by persons on the ground, in a vehicle, and/or in a building while the unmanned delivery vehicles 110 is traveling. In some embodiments, the display device 117 may comprise one or more of a liquid crystal display (LCD), a light-emitting diode (LED) display, an organic light emitting diode (OLED), a rotating LED display, an electronic ink display, and the like. Generally, the display device 117 may employ any conventional display technology suitable to be carried by an unmanned delivery vehicle 110. In some embodiments, the display device 117 may comprise one or more screens that face away from the unmanned delivery vehicle 110 in one or more directions. In some embodiments, the display device 117 may be carried on top, bottom, or one or more sides of the unmanned delivery vehicle 110. In some embodiments, the display device 117 may be integrated with one or more exterior surfaces of the unmanned delivery vehicles 110. In some embodiments, the display device 117 may comprise flat and/or curved displays. For example, in some embodiments, the display device 117 may form a cylinder or a polygonal tube around the unmanned delivery vehicles 110. In some embodiments, the screen of the display device 420 may be at least a minimal size (e.g. 10 cm, 20 cm, 50 cm, etc. in height or width) for visibility while the unmanned delivery vehicle 110 is traveling. Generally, the display device 420 may have a screen sufficiently large for a passerby to view the content displayed on the screen while the unmanned delivery vehicle 110 is traveling to and from delivery destinations.

In some embodiments, the unmanned delivery vehicle 110 may comprise an unmanned aerial vehicle (UAV) sometimes also referred to as aerial drones. An unmanned delivery vehicle 110 comprising a UAV may be configured to carry packages in flight while displaying content on the display device 117 carried by the UAV. A display device 117 on a UAV may be configured to display content for viewing from one or more of a ground and a building floor while the unmanned aerial vehicle is in flight. In some embodiments, the unmanned delivery vehicle 110 may be configured to turn on and off the display device 117 based on a flying altitude of the UAV and/or the height of the surrounding buildings. For example, in some embodiments, the display device 117 may be turned off if the flying altitude is above a set threshold above the height of the tallest building in a set radius from the unmanned delivery vehicle 110. In some embodiments, the unmanned delivery vehicle 110 may comprise a multicopter configured to hover at the destination for delivery and/or at one or more locations enroute to display content. For example, the UAV may comprise a quadcopter, or hexacopter, octocopter, etc. In some embodiments, the unmanned delivery vehicle 110 may further includes other typical components of the UAV such as a control circuit for navigating the UAV, motors for driving a plurality of propellers, a GPS sensor, a transceiver for communicating with a navigation server, and one or more navigation sensors such as range sensors for avoiding obstacles in the path of travel. An example of an unmanned delivery vehicle 110 comprising a UAV is described with reference to FIG. 4 herein.

In some embodiments, the unmanned delivery vehicle 110 may comprise an unmanned ground delivery vehicle. In some embodiments, an unmanned ground vehicle (UGV) may comprise one or more of a self-driving vehicle, a wheeled robot, an unmanned movable delivery unit, and the like. In some embodiments, the UGV may comprise one or more compartments for holding one or more packages for delivery. In some embodiments, the UGV may comprise a small wheeled device configured to travel on walkways such as sidewalks and bicycle lanes instead on automobile roadway. An unmanned delivery vehicle 110 comprising a UGV may transport packages while displaying content on the display device 117 on the exterior of the vehicle. In some embodiments, the unmanned delivery vehicle 110 may further includes other components of a UGV such as a control circuit for navigating the UAV, a motor for driving a plurality wheels, a GPS sensor, a transceiver for communicating with a navigation server, and one or more navigation sensors such as range sensors for avoiding obstacles in the path of travel. An example of an unmanned delivery vehicle 110 comprising a UGV is described with reference to FIG. 5 herein.

In some embodiments, the unmanned delivery vehicle 110 may further comprise one or more user interface devices such as a touchscreen, a microphone, and one or more buttons. In some embodiments, the unmanned delivery vehicle 110 may be configured to interact with users during a delivery trip via the user interface devices. For example, a user may ask the unmanned delivery vehicle 110 a question via a user interface device (e.g. “where can I buy that?”) and receive a response (e.g. direction and/or map to the store). In some embodiments, the unmanned delivery vehicle 110 may be configured to briefly stop on the delivery route while a user interacts with it. In some embodiments, at least some of the user interaction functions may be enabled only when the unmanned delivery vehicle 110 on a return segment of a delivery trip.

While in FIG. 1, the control circuit 111, the sensor 113, the memory 115, and the display device 117 are shown as part of the unmanned delivery vehicles 110, in some embodiments, one or more of the control circuit 111, the sensor 113, the memory 115, and the display device 117 may comprise a separate content display unit carried by the unmanned delivery vehicles 110. For example, a content display unit may be attached to the top, the bottom, and/or a side of the unmanned delivery vehicle 110 to display content. In some embodiments, the content display unit may be retrofitted onto an unmanned delivery vehicle originally without a display device. In some embodiments, the content display unit may be detachable from the unmanned delivery vehicle 110. In some embodiments, the content display unit may independently communicate with the content server 120. In some embodiments, the unmanned delivery vehicles 110 and the attached content display unit may share one or more of a power source, a wireless transceiver, and/or the sensor 113. In some embodiments, one or more of the control circuit 111, the memory 115, and the sensor 113 may comprise native components of the unmanned delivery vehicle 110 that are configured to both navigate the unmanned delivery vehicle 110 and control the display of the content on the display device 117. In some embodiments, the unmanned delivery vehicle 110 may comprise an unmanned vehicle with an integrated display device 117.

The content server 120 comprises a control circuit 121 and a memory 123 device. The content server 120 may comprise one or more of a server, a central computing system, a delivery management computer system, and the like. In some embodiments, the content server 120 may comprise a system of two or more processor-based devices. The control circuit 121 may comprise a processor, a microprocessor, and the like and may be configured to execute computer readable instructions stored on a computer readable storage memory 123. The computer readable storage memory 123 may comprise volatile and/or non-volatile memory and have stored upon it a set of computer readable instructions which, when executed by the control circuit 121, cause the system to instruct the unmanned delivery vehicle 110 to travel to one or more delivery locations while displaying content on the display device 117 based on context information. In some embodiments, the content server 120 may further be configured to determine a delivery route for the unmanned delivery vehicle 110 based on target contexts of one or more content items. In some embodiments, the computer executable instructions may cause the control circuit 121 of the content server 120 to perform one or more steps in the methods and processes described with reference to FIGS. 2-3 herein.

The content server 120 may be coupled to a content database 140 and/or a context database 150 via a wired and/or wireless communication channel. In some embodiments, one or more of the content database 140 and the context database 150 may be at least partially implemented with the memory 123 of the content server 120. The content database 140 may have stored upon it a plurality content items configured to be displayed on the display device 117 of the unmanned delivery vehicle 110. In some embodiments, the content items may comprise one or more of a product advertisement, a service advertisement, an offer, a restaurant menu, a branding content, a store location, an event reminder, and directions. Generally, a content item may comprise any image, video, and/or audio file. In some embodiments, one or more content items may be associated with a target context. Target context generally refers to the content item's preferred or required display context. In some embodiments, target context may comprise one or more of an unmanned delivery vehicle location, an area demographic information, an area environmental condition, an area customer purchase history, a current time, and a current date. For example, a content item corresponding to a restaurant lunch special advertisement may have a target time frame of 10 AM-12 PM, target location of a set radius (e.g. 5 miles) around the restaurant location, and a target demographic of office workers. In another example, a content item corresponding to a gardening service advertisements may have a target location corresponding to the company's service area and the target demographic of residents of single-family homes. In some embodiments, the target context may be specified by the provider of the content (e.g. advertiser). In some embodiments, the target context may be adjusted based on effectiveness comparisons. For example, the system may keep track of the response rate (e.g. increase in produce purchased, increase in service inquiries, increase in website traffic, etc.) of advertising a product or a service to different demographics and/or geographic areas, identify the most effective target demographic/area, and adjust target context of the product or service based on the response rate.

The context database 150 may have stored upon it context information for one or more areas and/or users covered by a delivery service. In some embodiments, the context database 150 may store area demographic information, area building type information, area user shopping trend data, area historical climate information, traffic patterns of one or more roads, pedestrian patterns of one or more areas, and the like. In some embodiments, the control circuit 121 may retrieve context information from the context database 150 using the current location and/or a planned route of the unmanned delivery vehicle 110. In some embodiments, the context database 150 may store user profiles comprising one or more of user preference, user demographic, user purchase history, etc. In some embodiments, the sensor 113 on the unmanned delivery vehicle 110 may detect for the presence of one or more user devices 130 associated with users in its proximate area. The content server 120 may retrieve user profiles from the context database 150 based on the user devices 130 detected by the sensor 113.

In some embodiments, the control circuit 121 may compare the context information detected by the sensor 113 and/or retrieved from the context database 150 with the target contexts associated with one or more content items stored in the content database 140 to select one or more content items to display on the display device 117. In some embodiments, the content server 120 be configured to determine a route for the unmanned delivery vehicle 110 based comparing the target context of content items in the content database 140 and context information of areas in its service area stored in the context database 150. In some embodiments, the content server 120 may be configured to cause the unmanned delivery vehicle to travel on a route determined based on prioritizing one or more geographic areas based on one or more of: an area automobile traffic pattern, an area foot traffic pattern, an area building type, an area demographic, and an area flight height clearance. In some embodiments, the content server 120 may be configured to cause the unmanned delivery vehicle to travel on a route determined based on prioritizing one or more geographic areas based on comparing demographic information of areas near a direct route with target demographic of one or more selected content items. Examples of functions that may be performed by the content server are described in further detail with reference to FIGS. 2 and 3 herein.

The user device 130 may generally comprise any processor-based mobile device. In some embodiments, the user device 130 may comprise one or more of a mobile phone, a smartphone, a tablet device, a mobile computer, a vehicle dashboard system, a wearable device, and the like. The user device 130 may generally be a device associated with and/or carried by a user. The device may generally be carried by a pedestrian, located in a vehicle, a home, an office, a shopping space, etc. The user device 130 includes a control circuit 131 and a memory 132. The control circuit 131 may comprise a central processing unit, a processor, a microprocessor, and the like. The control circuit 131 may be configured to execute computer readable instructions stored on a computer readable storage memory 132. The computer readable storage memory 132 may comprise volatile and/or non-volatile memory and have stored upon it a set of computer readable instructions which, when executed by the control circuit 131, causes the system to communicatively couple with the unmanned delivery vehicle 110 and/or the content server 120. In some embodiments, a mobile application (“app”) may be installed on the memory 132 for interacting with the unmanned delivery vehicles 110 and/or the content server 120. The mobile application may allow a user to register with and/or log-in to an account associated with the delivery vehicle content display service. In some embodiments, one or more user profiles may be stored on the memory 132. A user profile may store the user's account information, preference, demographic information, shopping history and the like. In some embodiments, the content server 120 and/or the unmanned delivery vehicle 110 may select content to display based on using the information in the user profile as context information. In some embodiments, the mobile application may be configured to display content on the user device 130 based on the communication with the unmanned delivery vehicle 110 and/or the content server 120. For example, if a user is near the display device 117 advertising an item, the mobile application may automatically display related a produce page and/or an order screen on the user device 130 when the user accesses the applications. In some embodiments, the mobile application may determine the content to display on the user device 130 by detecting for wireless signals broadcasted by the unmanned delivery vehicle 110. For example, the unmanned delivery vehicle 110 may broadcast a code associated with the displayed content and the mobile application may be configured to retrieve the relevant information using the code. In some embodiments, the content to display on the user device 130 may be determined by the content server 120 by comparing the location of the unmanned delivery vehicle 110 and the user device 130. In some embodiments, the functionalities of the mobile application described herein may be provided via a web interface accessible by a web browser.

In some embodiments, the user device 130 may include a communication device that is configured to directly communicate with the unmanned delivery vehicle 110. For example, the user device may include a short range radio frequency transceiver (e.g. Bluetooth, Wi-Fi), a mobile data network transceiver (e.g. 3G, 4G), and the like. In some embodiments, the communication device of the user device 130 may broadcast a signal detectable the unmanned delivery vehicle 110 and/or may detect a signal broadcasted by the unmanned delivery vehicle 110. In some embodiments, the communication device of the user device 130 may be configured to communicate with a content server 120. The user device 130 may also include user input/output devices such as a display device, a touch screen, one or more keys, a microphone, a speaker, and the like, for interacting with a content display user interface displayed on the user device and/or the content displayed on the display device 117 of the unmanned delivery vehicle 110. While FIG. 1 shows the user device 130 communicating directly with the unmanned delivery vehicle 110, in some embodiments, the user device 130 may communicate with the unmanned delivery vehicle 110 and/or the content server 120 via the internet. In some embodiments, the user device 130 may be optional to the system and the content displayed on the display device 117 is configured to be only affected by the unmanned delivery vehicle 110 and/or the content server 120.

Referring now to FIG. 2, a method for providing delivery vehicle content display is shown. Generally, the method shown in FIG. 2 may be implemented with a processor-based device such as a control circuit, a central processor, and the like. In some embodiments, the method shown in FIG. 2 may be implemented with the control circuit 111 of the unmanned delivery vehicle 110 and/or a processor-based server device such as the content server 120. In some embodiments, each step shown in FIG. 2 may be performed by one or more of a central server, an unmanned delivery vehicle, a content display unit attached to an unmanned delivery vehicle, and/or a mobile application running on a user device.

In step 210, the system detects data for determining context information. The context information may generally be associated with the context of the unmanned delivery vehicle during a delivery trip. In some embodiments, the data may be collected in transmit between a dispatch location and one or more delivery locations. In some embodiments, the data may be detected via a sensor on the unmanned delivery vehicle. The sensor may comprise one or more of a global positioning system (GPS) sensor, a mobile data transceiver, and a Wi-Fi transceiver. In some embodiments, the system may comprise an environmental sensor such as a temperature sensor, a humidity sensor, a light sensor, a noise level sensor, a wind sensor, an air quality sensor, and the like and the measured environmental data may be used as context information. In some embodiments, context information may comprise one or more of an unmanned delivery vehicle location, an area demographic information, an area environmental condition, an area customer purchase history, a current time, and a current date. In some embodiments, the collected data may correspond to the location of the unmanned delivery vehicle and the location information may be used to retrieve one or more of an area demographic information, an area environmental condition, an area customer purchase history, and the like from a context database to use as context information. In some embodiments, the system may communicate with one or more of a user device, a wireless router, and a mobile data tower to collect context information. For example, a user device within communication range of the system may include a mobile application for communicating with the unmanned delivery vehicle and providing user's information to the unmanned delivery vehicle 110. The provided user information may comprise one or more of user location, user preference, user demographic, user purchase history, etc. In some embodiments, the aggregated individual user information may comprises context information.

In step 220, the system causes a display device on the exterior of the unmanned delivery vehicle to display content comprising a content item. The content item may be selected from a plurality of content items based on the context information determined in step 210. The display device may comprise any display device configured to be viewed by persons on the ground, in a vehicle, and/or in a building while the unmanned delivery vehicles is traveling. In some embodiments, the display device may comprise one or more of a liquid crystal display (LCD), a light-emitting diode (LED) display, an organic light emitting diode (OLED), a rotating LED display, an electronic ink display, and the like. Generally, the display device may employ any conventional display technology. In some embodiments, the display device may be carried on top, bottom, or a side of the unmanned delivery vehicle. In some embodiments, the display device may be integrated with one or more exterior surfaces of the unmanned delivery vehicle. In some embodiments, the unmanned delivery vehicle may comprise an UAV configured to transport a package and the display device may be configured to display the content for viewing from one or more of a ground and a building floor while the unmanned aerial vehicle is in flight. In some embodiments, the unmanned delivery vehicle comprises a wheeled UGV.

In some embodiments, the content item may be selected at the unmanned delivery vehicle and/or at a content server remote to the unmanned delivery vehicle during transit. In some embodiments, the unmanned delivery vehicle may have preloaded on its memory, a plurality of content items and the control circuit on board the vehicle may select a locally stored content item to display based on the context information. In some embodiments, the context information may be sent back to the content server that selects and communicates one or more content items back to the unmanned delivery vehicle to display. In some embodiments, the content server may supplement other types of context data to the context information determined in step 210 in the selection of the content item.

In some embodiments, the content item may comprise one or more of a product advertisement, a service advertisement, an offer, a restaurant menu, a branding content, a store location, an event reminder, directions, etc. In some embodiments, one or more content items may be associated with a target context. Target context generally refers to the content item's preferred or required display context. In some embodiments, the target context may comprise one or more of an unmanned delivery vehicle location, an area demographic information, an area environmental condition, an area customer purchase history, a current time, and a current date. For example, a content item corresponding to restaurant lunch special advertisement may have a target time frame of 10 AM-12 PM, target location of a set radio (e.g. 5 miles) around the restaurant location, and a target demographic of office workers. In another example, a content item corresponding to a gardening service advertisements may have a target location corresponding to the company's service area and the target demographic of residents of single-family homes. In some embodiments, the target context may be specified by the provider of the content (e.g. advertiser). In some embodiments, the target context may be adjusted based on effectiveness comparisons. In some embodiments, the unmanned delivery vehicle may be configured to display a default content item (e.g. advertisement of the delivery service, the associated merchant, etc.) if the context information does not match the target context of one or more content items. A control circuit on the unmanned delivery vehicle may then cause the display device to display content based on instructions received from the remote server via a wireless communication device.

In step 230, the system updates the content displayed on the display device. The content may be updated based a change in the context information associated with the unmanned delivery vehicle during the delivery trip. During a trip, the context information may be continuously determined and the system may select different content items based on the changing context information. For example, an unmanned vehicle passing through an office park area, a shopping area, and a residential area on the way to a delivery destination may display different content in each area on its route (e.g. professional services in the office park, store promotions in the shopping area, and family event promotions in the residential area). In another example, a content item may have a target advertising area (e.g. a set radius from the store or restaurant), and the content item may be replaced by another content item when the unmanned delivery vehicle leaves the target area. In yet example, an advertisement for a cold drink at a coffee store may change to an advertisement for a hot drink if the temperature in the area of the unmanned delivery vehicle drops below a threshold temperature (e.g. 65 degrees Fahrenheit), during a specified time of day (e.g. between 6-11 am), and/or during a specified period of a year (e.g. between October-March).

In some embodiments, steps 210-230 may be repeated throughout a delivery trip. In some embodiments, the updating in step 230 may be performed only after a content item has been displayed for a minimum threshold of time (e.g. 1 minute, 2 minutes). In some embodiments, a display device and/or an unmanned delivery vehicle may be configured to simultaneously display a plurality of content items. For example, if one side of the unmanned delivery vehicle faces an office building and the opposite side of the vehicle faces a residential area during a segment of a delivery trip, different content may be selected for each side's display device based on the expected demographic of the respective sides. In some embodiments, the display device may be split to display a plurality of content items (e.g. different advertisements, news items, event reminders, delivery information, etc.) in different areas of the display device. In some embodiments, the display of the content may be suspended for at least a portion of the delivery trip. For example, if the flying altitude of a UAV type delivery vehicle exceeds a threshold height, the display of the content may be suspended and the display device may be turned off. In some embodiments, if the estimated number of potential audience is below a threshold in an area (e.g. scarcely populated areas), the display may be suspended while the unmanned delivery vehicle travels through that area.

Referring now to FIG. 3, a method for providing delivery vehicle content display is shown. Generally, the method shown in FIG. 3 may be implemented with a processor-based device such as a control circuit, a central processor, and the like. In some embodiments, the method shown in FIG. 3 may be implemented with the control circuit 121 of the content server 120 and/or the control circuit 111 of the unmanned delivery vehicle 110. In some embodiments, each step shown in FIG. 3 may be performed by one or more of a central server, an unmanned delivery vehicle, a content display unit attached to an unmanned delivery vehicle, and/or a mobile application running on a user device.

In step 310, the system determines one or more delivery destinations for the unmanned delivery vehicles. In some embodiments, the destinations may be selected based on delivery orders placed with the system having delivery destinations within a service area associated with the dispatch location of the unmanned delivery vehicles. In some embodiments, destinations may be grouped based on geographical and delivery time proximity for deliveries.

In step 320, the system determines a route for an unmanned delivery vehicle. In some embodiments, the route may be determined based minimizing the travel time and/or distance to complete the deliveries. Generally, the route may be determined such that the unmanned delivery vehicle visits each of the one or more destinations selected in step 310.

In some embodiments, the route may be determined based on the target content of one or more content items to be displayed on the display device of the delivery vehicle. In some embodiments, the delivery route may be determined based on prioritizing one or more geographic areas based on comparing demographic information of areas near a direct route with target demographic of one or more selected content items. For example, the system may add a detour and/or select a slightly longer route to cause the unmanned delivery vehicle to travel through or near an area (e.g. neighborhood park) with demographics (e.g. parents) target by a content item (e.g. advertisement for back to school supplies). In some embodiments, the route may be determined based on prioritizing one or more geographic areas based on one or more of: an area automobile traffic pattern, an area foot traffic pattern, an area building type, an area demographic, and an area flight height clearance. For example, the route may be determined by prioritizing areas with a large volume of pedestrian traffic and/or high rises with street facing windows over less populated areas to increase the content item's exposure. In some embodiments, the system may rate a plurality of areas based on the estimated audience volumes in the areas and/or by how well the areas match the target context of one or more content items. The system may then include one or more areas with high ratings in the planned route of the unmanned delivery vehicle even if the resulting route is not the fastest and/or shortest route. In some embodiments, the system may set an increased distance and/or travel time threshold for modifying the route based on the potential audience volume and/or target context of content items. For example, the determine route may be permitted to exceed the shortest route by a set travel time (e.g. 10 more minutes), a set percentage of travel time (e.g. 10% more time), a set travel distance (e.g. 3 miles), and/or a set percent travel distance. In some embodiments, the permitted increase in distance and/or time may be based on an estimated number of increased general audience and/or audience in the targeted demographic. For example, a 5 minutes detour may be permitted if the detour is estimated to add 50 more views while a detour that could add 10 more views may be permitted only no more than 3 minutes is added to the route. After step 320, the system then instructs the unmanned delivery vehicle to begin its delivery trip.

In step 330, the system receives sensor data from the unmanned delivery vehicle. The sensor data may comprise vehicle location and/or other environmental conditions. In step 340, the system determines the context information of based at least on the sensor data received in step 330. In some embodiments, the context information may comprise information directly received from the unmanned delivery vehicles (e.g. current temperature, traffic conditions, wind speed, etc.). In some embodiments, context information comprises information retrieved from a context database based on the sensor data (e.g. area demographic and/or building types based on GPS coordinate) and/or supplemented by the system (e.g. current time of day, upcoming holidays, etc.).

In step 350, the system selects a content item from a plurality of content items based on the context information. In some embodiments, the system may compare the current context of the unmanned delivery vehicle with target context of one or more content items in its content database to select one or more content items for the unmanned delivery vehicle to display. In some embodiments, the system may select a plurality of content items to be displayed simultaneously or in rotation in step 350. In some embodiment, content items for displays facing different directions may be selected separately in step 350. For example, if during a segment of a delivery trip, one side of the unmanned delivery vehicle faces an office building and the opposite side of the vehicle faces a residential area, different content may be selected for each side's display screen based on the expected viewer demographic of the respective sides.

In some embodiments, steps 340 and 350 may be performed based on the route determine in step 320. For example, the content items may be selected and associated with segments of the route prior to the delivery trip. During the trip, the system may then provide the pre-select the content item to the unmanned delivery vehicle based on the current location of the vehicle alone. In some embodiments, one or more of the content items may be preloaded onto an on-board memory device of the unmanned delivery vehicle. The unmanned delivery vehicle may then select a content item based on its location and/or other context information.

In step 360, the system causes the display device on the unmanned delivery vehicle to display the content item selected in step 350. In some embodiments, the system may further specify a duration that the content item should be displayed. In some embodiments, the display device may be configured to display a plurality of content items simultaneously and the system may also specify a display location of one or more of the content items in step 360. For example, if the unmanned delivery vehicle has displays on two or more sides, the system may specify which content item(s) should be displayed on each side.

In step 370, the content displayed on the display device is updated. The update of displayed content may be based on a change in the context information associated with the unmanned delivery vehicle during the delivery trip. During a trip, the context information may be continuously determined and the system may select different content based on the changing context information. In some embodiments, a central server may continuously provide content to the unmanned delivery vehicle to display based on the changing context information. In some embodiments, one or more content items may be preloaded onto the memory device of the unmanned delivery vehicle and the unmanned delivery vehicle may select from the preloaded content items to update the displayed content when the context changes during the delivery trip. In some embodiments, the displayed content may also change based on interactions with users. For example, a user may approach an unmanned delivery vehicle and ask a question. The unmanned vehicle and/or the content server may be configured to respond to the question via the display device and/or a speaker on the unmanned delivery vehicle. In some embodiments, the unmanned delivery vehicle may be configured to interact with one or more user devices via a wireless connection. In some embodiments, the display of content selected based on context information may resume after the user interaction. In some embodiments, steps 330 to 370 may be repeated until the delivery vehicle returns to the dispatch location.

Next referring to FIG. 4, an illustration of an unmanned aerial vehicle 410 with a display device 420 is shown. The UAV 410 includes a set of propellers configures to lift and steer the UAV 410. While four propellers are shown, a UAV may generally include any number of propellers without departing from the spirit of the present invention. The display device 420 in FIG. 4 hangs slightly below the arms connecting to the propeller and surrounds a portion of the body of the UAV 410. The display device 420 is generally cylindrical in shape and visible from different angles around the UAV 410. The display device 420 is shown as an example only. In some embodiments, a display device may be carried on top of the UAV 410, hang further below the UAV 410, and/or integrated with the body of the UAV 410. In some embodiments, the display device 420 may comprise a ground facing display. In some embodiments, the display device 420 may comprise one or more flat and/or curved displays. For example, the display device may comprise two back-to-back display screens. In another example, the display device may comprise a plurality of screens arranged in a polygonal tube or cube. In some embodiments, the UAV 410 may simultaneously carry one or more packages for delivery below the body of the UAV 410. In the setup shown in FIG. 4, the package may hang below and/or within the display device 420. In some embodiments, the package may be carried via a sky crane comprising an extendable cable for lowering the package, and the display device 420 may at least partially surround the sky crane assembly.

Next referring to FIG. 5, an illustration of a unmanned ground vehicle (UGV) 510 with a display device 520 is shown. The UGV 510 includes set(s) of wheel configures to drive and steer the UGV 510 on the ground. While two wheels are shown, a UGV may generally include any number of wheels and/or other locomotion devices without departing from the spirit of the present invention. The display device 520 in FIG. 5 is shown to be integrated with the exterior of the UGV 510. In some embodiments, the display device 520 may follow the curvature of the exterior of the UGV 510. In some embodiments, the display device 520 may cover one or more sides and/or the top of the UGV 510. The display device 520 is shown as an example only. In some embodiments, a display device may be carried on top of the UGV 510 and/or hang in the front, back, or one or more sides of the UGV. In some embodiments, the display device may comprise one or more flat screen or curved displays and may be integrated with or attached to the UGV 510. In some embodiments, the UGV 510 may simultaneously carry one or more packages in a compartment on the body of the UGV 510. In some embodiments, the display device 520 may also be configured to interact with a recipient retrieving the package. For example, the package may be secured within a locked compartment of the UGV 510 and the user may enter a passcode via the display device 520 and/or other input devices to retrieve the package.

In some embodiments, unmanned delivery vehicles may present signage, advertisements, information, and/or other contents based on changing contexts such as audience, window of opportunity, relevancy, and other aspects. Traditional advertisements are typically attached to buildings and structures and do not include location based customized presentations.

In some embodiments, dynamic advertising with an unmanned delivery vehicle may utilize graphical displays, LED displays, and other electronic signage to present content such as text, pictures, graphic images, symbols, sound, or colors. The content may be managed by a central computer, continuously revised, and/or presented as needed in response to observed or derived context. In some embodiments, factors considered for selecting content may include one or more of: sensor input from the unmanned vehicle, task information, order details, customer profiles, geo-location data, demographics, calendar events, current events, and user interactions.

System and methods described herein may enable an unmanned vehicle to present customized advertising and/or more personalized communications by linking awareness of location, sensors, and/or other information to the display. In some embodiments, unmanned delivery vehicles may be configured to concurrently advertise or display information while performing other tasks and/or while in transit. The displayed content may be tailored to suit conditions, audience and/or geo-locations on the route. In some embodiments, unmanned delivery vehicles may display content that is relevant to the demographics, date, events or other aspects of its surrounding while delivering packages. For example, an unmanned delivery vehicle may display a restaurant's deli menu and contact information as it passes a row of office windows on its way to deliver a package to a destination.

In some embodiments, the unmanned delivery vehicle may be fitted with one or more display/communication devices such as a tablet device, a graphical display, an LED array, a lighted signage, and/or speakers. In some embodiments, contents that an unmanned delivery vehicle may be configured to displayed may comprise one or more of: related products, special offers, today's lunch menu, merchant logo, store source location (e.g. closest store), merchant web address, product reminders, event reminders, service reminders (e.g. layaway service, site to store service), and typical delivery speed of the delivery service. In some embodiments, information that may be factored into the selection of the content to display may comprise one or more of: geo-location information, customer product order, demographics, time of day (e.g. lunch, rush hour), day of week (workday, weekend), date (normal, special, holidays).

In some embodiments, the displayed content may include information and/or direction. For example, the unmanned vehicle may ask the viewers to follow it to a destination such as an advertised store location, may lead a viewer to their vehicle, and/or may provide store contact information or website to place orders. In some embodiments, the display content may change in response to interactions or input from viewers, change in vehicle location, customer query, and/or expected audience. For example, different content may be displayed when a vehicle passes an office building versus a residential community.

In one embodiment, a system for delivery vehicle content display comprises an unmanned delivery vehicle, a display device on an exterior of the unmanned delivery vehicle, a sensor configured to collect data for determining context information associated with the unmanned delivery vehicle during a delivery trip, and a control circuit coupled to the display device and the sensor. The control circuit being configured to cause the display device to display content comprising a content item selected from a plurality of content items based on the context information during the delivery trip and update the content displayed on the display device based on a change in the context information associated with the unmanned delivery vehicle during the delivery trip.

In one embodiment, a method for delivery vehicle content display comprises detecting, with a sensor on an unmanned delivery vehicle, data for determining context information associated with the unmanned delivery vehicle during a delivery trip, causing, with a control circuit and during the delivery trip, a display device on an exterior of the unmanned delivery vehicle to display content comprising a content item selected from a plurality of content items based on the context information, and updating, with the control circuit, the content displayed on of the display device based on a change in the context.

In one embodiment, a method for delivery vehicle content display comprises determining one or more delivery destinations for an unmanned delivery vehicle, determine a route for the unmanned delivery vehicle based on the one or more delivery destinations, and while the unmanned delivery vehicle is on a delivery trip: receiving data from a sensor on the unmanned delivery vehicle, determining a context information associated with the unmanned delivery vehicle based on the data, selecting a content item from a plurality of content items based on the context information, causing a display device on an exterior of the unmanned delivery vehicle to display content comprising the content item, updating a content displayed on of the display device based on a change in the context information associated with the unmanned delivery) vehicle during the delivery trip.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1: A system for delivery vehicle content display comprising:
an unmanned delivery vehicle;
a display device on an exterior of the unmanned delivery vehicle;
a sensor configured to collect data for determining context information associated with the unmanned delivery vehicle during a delivery trip; and
a control circuit coupled to the display device and the sensor, the control circuit being configured to:
cause the unmanned delivery vehicle to travel on a route determined based on prioritizing one or more geographic areas based on comparing demographic information of areas near a direct route with target demographic of one or more selected content items;
cause the display device to display content comprising a content item selected from a plurality of content items based on the context information during the delivery trip; and
update the content displayed on the display device based on a change in the context information associated with the unmanned delivery vehicle during the delivery trip.

2: The system of claim 1, wherein the unmanned delivery vehicle comprises an unmanned aerial vehicle configured to transport a package.

3: The system of claim 2, wherein the display device is configured to display the content for viewing from one or more of a ground and a building floor while the unmanned aerial vehicle is in flight.

4: The system of claim 1, wherein the unmanned delivery vehicle comprises an unmanned ground vehicle.

5: The system of claim 1, wherein the control circuit causes the display device to display content based on instructions received from a remote server via a wireless communication device.

6: The system of claim 1, wherein the sensor comprises one or more of a global positioning system (GPS) sensor, a mobile data transceiver, and a Wi-Fi transceiver.

7: The system of claim 1, wherein the context information comprises one or more of: an unmanned delivery vehicle location, an area demographic information, an area environmental condition, an area customer purchase history, a current time, and a current date.

8: The system of claim 1, wherein the control circuit is further configured to cause the unmanned delivery vehicle to travel on a route determined based on prioritizing one or more geographic areas based on one or more of: an area automobile traffic pattern, an area foot traffic pattern, an area building type, an area demographic, and an area flight height clearance.

9. (canceled)

10: The system of claim 1, the plurality of content items comprises one or more of: a product advertisement, a service advertisement, an offer, a restaurant menu, a branding content, a store location, an event reminder, and directions.

11. A method for delivery vehicle content display comprising:
detecting, with a sensor on an unmanned delivery vehicle, data for determining context information associated with the unmanned delivery vehicle during a delivery trip;
causing the unmanned delivery vehicle to travel on a route determined based on prioritizing one or more geographic areas based on comparing demographic information of areas near a direct route with target demographic of one or more selected content items;
causing, with a control circuit and during the delivery trip, a display device on an exterior of the unmanned delivery vehicle to display content comprising a content item selected from a plurality of content items based on the context information; and
updating, with the control circuit, the content displayed on of the display device based on a change in the context information associated with the unmanned delivery vehicle during the delivery trip.

12: The method of claim 11, wherein the unmanned delivery vehicle comprises an unmanned aerial vehicle configured to transport a package.

13: The method of claim 12, wherein the display device is configured to display the content for viewing from one or more of a ground and a building floor while the unmanned aerial vehicle is in flight.

14: The method of claim 11, wherein the unmanned delivery vehicle comprises an unmanned ground vehicle.

15: The method of claim 11, wherein the control circuit causes the display device to display content based on instructions received from a remote server via a wireless communication device.

16: The method of claim 11, wherein the sensor comprises one or more of a global positioning system (GPS) sensor, a mobile data transceiver, and a Wi-Fi transceiver.

17: The method of claim 11, wherein the context information comprises one or more of: an unmanned delivery vehicle location, an area demographic information, an area environmental condition, an area customer purchase history, a current time, and a current date.

18: The method of claim 11, further comprising: causing the unmanned delivery vehicle to travel on a route determined based on prioritizing one or more geographic areas based on one or more of: an area automobile traffic pattern, an area foot traffic pattern, an area building type, an area demographic, and an area flight height clearance.

19. (canceled)

20: The method of claim 11, the plurality of content items comprises one or more of: a product advertisement, a service advertisement, an offer, a restaurant menu, a branding content, a store location, an event reminder, and directions.

21: A method for delivery vehicle content display comprising:
determining one or more delivery destinations for an unmanned delivery vehicle;
determine a route for the unmanned delivery vehicle based on the one or more delivery destinations;
while the unmanned delivery vehicle is on a delivery trip:
receiving data from a sensor on the unmanned delivery vehicle;
determining a context information associated with the unmanned delivery vehicle based on the data;
selecting a content item from a plurality of content items based on the context information;
causing a display device on an exterior of the unmanned delivery vehicle to display content comprising the content item; and
updating a content displayed on of the display device based on a change in the context information associated with the unmanned delivery vehicle during the delivery trip;
wherein the route is determined based on prioritizing one or more geographic areas based on comparing demographic information of areas near a direct route with target demographics of one or more selected content items.

22: The method of claim 21 wherein the route is determined based on prioritizing one or more geographic areas based on one or more of: an area automobile traffic pattern, an area foot traffic pattern, an area building type, an area demographic, and an area flight height clearance.

23. (canceled)
